(19) United States
(12) Patent Application Publication
(10) Pub. No.: US 2007/0012395 A1
(43) Pub. Date: Jan. 18, 2007

(54) Methods involving processing of a continuous web at a desired location in relationship to the actual location of a discrete part

(76) Inventors: Jennifer Lynn Tuertscher, Cincinnati, OH (US); Nathan Alan Gill, Cincinnati, OH (US); Michael Joseph Lamping, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/182,422

(22) Filed: Jul. 15, 2005

(51) Int. Cl. B32B 37/22; B32B 38/00; B32B 38/04; B32B 38/14

(52) U.S. Cl. 156/64; 156/250; 156/253; 156/277

(57) ABSTRACT

A method of forming a discrete product from a continuous web of material. The discrete product having a discrete part and a minimum distance from the discrete part to its end edge. The method may include the steps of providing a continuous web of material, placing a discrete part onto the web of material, determining the location of the discrete part on the web of material, phasing a subsequent process in relation to the location of the discrete part and performing the subsequent process in such a way so as to preserve a minimum distance from the discrete part.

### FIELD OF THE INVENTION

The present invention relates to methods involving processing of a continuous web at a desired location. More specifically, the present invention relates to methods involving processing of a continuous web at a desired location in relationship to the actual location of a discrete part.

### BACKGROUND OF THE INVENTION

A wide variety of consumer products are made from at least one continuous web of material. For example, a plurality of absorbent articles is made from at least one continuous web of material. Such web materials include, but are not limited to, non-wovens and films. In addition, said consumer products may also include discrete parts which are added to said web of material. For example, back ears may be added to the rear portion of an absorbent article. Lastly, these discrete consumer products (e.g., absorbent articles) may be formed by the severing of said web(s) of material(s), along with said discrete parts, to create a plurality of said products. Sometimes the location of the actual severing (i.e., cut) as it relates to at least one of said discrete parts is critical. For example, the location of a knife cut of a continuous web of absorbent articles in relationship to the location of the back ear may be critical. If the knife cut is too close to the discrete part, then the discrete part is likely to get severed resulting in an unsatisfactory product. If the knife cut is too far removed from the discrete part (often referred to as a “top hat” in the art), then web material may excessively extend beyond the discrete part resulting in an unsatisfactory product. Accordingly, a method of manufacture is needed that provides the proper location of a severing operation, or like operation, in relation to the variable placement of a discrete part.

### SUMMARY OF THE INVENTION

The present invention consists of a method of forming a discrete product from a continuous web of material, where the discrete product contains a discrete part and a minimum distance from the discrete part to its end edge. The method may include the steps of providing a continuous web of material, placing a discrete part onto the web of material, determining the location of the discrete part on the web of material, phasing a subsequent process in relation to the location of the discrete part and performing the subsequent process in such a way so as to preserve a minimum distance from the discrete part.

The subsequent process may be selected from the group consisting of severing, perforating, bonding, imprinting and printing. The discrete part may be selected from the group consisting of a back ear, a front ear, an absorbent core, a landing zone and a wing on a feminine product. The location of the discrete part on the web of material is determined by the sensing of a product component selected from the group consisting of a leading edge of a discrete part, the leading edge of an absorbent core, a cut within the product, a registration on the product and a graphic on the product.

The subsequent process may include the severing of the web of continuous material and further include the use of a knife roll having a knife blade. The subsequent process may further include the use of an anvil roll to facilitate the severing process.

The subsequent process may include the severing of the web of continuous material thus causing the formation of an end edge, wherein a minimum distance between the discrete part and the end edge is preserved. The minimum distance may be measured by a reference counting system.

The location of the discrete part on the web of material may be determined by the use of a camera or other suitable device.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. None of the drawings are necessarily to scale.

FIG. 1 shows an exemplary continuous web of material that would be suitable for the manufacture of absorbent articles;

FIG. 2 shows the web and master referencing of FIG. 1 along with the addition of discrete parts;

FIG. 3 shows the web and master referencing of FIG. 2 along with the addition of subsequent processing;

FIG. 4a shows an exemplary severing operation wherein a knife blade in an initial position;

FIG. 4b shows the severing operation of FIG. 4a wherein the knife blade is rotated approximately 180°;

FIG. 4c shows the severing operation of FIG. 4a wherein the knife blade is completely rotated;

FIG. 5 shows an exemplary chart demonstrating the relationship between the master reference count system and the motor encoder count system;

FIG. 6 shows an ideal yet unrealistic product formation;

FIG. 7 shows an undesirable yet realistic product formation known in the prior art;

FIG. 8a shows the first discrete product from FIG. 7;

FIG. 8b shows the second discrete product from FIG. 7;

FIG. 8c shows the third discrete product from FIG. 7;

FIG. 9 shows an exemplary flowchart that may be used to remedy the aforementioned placement problems;

FIG. 10 shows an exemplary sensor 888 being used to sense a region of interest along a leading edge of a back ear;

FIG. 11a shows an ideal discrete product wherein the leading edge of back ear was properly placed at the target location identified as master reference 900 (MR₉₀₀);

FIG. 11b shows an exemplary cam profile graph of the speed changes incurred by knife blade as it relates to the cutting of first discrete product of FIG. 11a;

FIG. 12a shows a second discrete product wherein the leading edge of back ear was placed too early onto web material at a master reference count value of 850 (MR₈₅₀);

FIG. 12b shows an exemplary cam profile graph of the speed changes incurred by knife blade as it relates to the cutting of second discrete product of FIG. 12a;

FIG. 12c shows an exemplary cam profile graph of the speed changes incurred by knife blade as it relates to the cutting of second discrete product of FIG. 12a;

FIG. 13a shows a third discrete product wherein the leading edge of back ear was placed too late onto web material at a master reference count value of 950 (MR₉₅₀);

FIG. 13b shows an exemplary cam profile graph of the speed changes incurred by knife blade as it relates to the cutting of third discrete product of FIG. 13a; and

FIG. 13c shows an exemplary cam profile graph of the speed changes incurred by knife blade as it relates to the cutting of third discrete product of FIG. 13a.

### DETAILED DESCRIPTION OF THE EMBODIMENTS

Various definitions of terms used herein are provided as follows:

The term “absorbent article” herein refers to devices which absorb and contain body exudates and, more specifically, refers to devices which are placed against or in proximity to the body of the wearer to absorb and contain the various exudates discharged from the body, such as: incontinence briefs, incontinence undergarments, absorbent inserts, diaper holders and liners, feminine hygiene garments and the like. The absorbent article may have an absorbent core having a garment surface and a body surface; a liquid permeable topsheet positioned adjacent the body surface of the absorbent core; and a liquid impermeable backsheet positioned adjacent the garment surface of the absorbent core.

The term “disposable” is used herein to describe absorbent articles which generally are not intended to be laundered or otherwise restored or reused as absorbent articles (i.e., they are intended to be discarded after a single use and, preferably, to be recycled, composted or otherwise discarded in an environmentally compatible manner).

The term “diaper” herein refers to an absorbent article generally worn by infants and incontinent persons about the lower torso.

The term “pant”, as used herein, refers to disposable garments having a waist opening and leg openings designed for infant or adult wearers. A pant may be placed in position on the wearer by inserting the wearer's legs into the leg openings and sliding the pant into position about the wearer's lower torso. A pant may be preformed by any suitable technique including, but not limited to, joining together portions of the article using refastenable and/or non-refastenable bonds (e.g., seam, weld, adhesive, cohesive bond, fastener, etc.). A pant may be preformed anywhere along the circumference of the article (e.g., side fastened, front waist fastened). While the term “pant” is used herein, pants are also commonly referred to as “closed diapers”, “prefastened diapers”, “pull-on diapers”, “training pants” and “diaper-pants”. Suitable pants are disclosed in U.S. Pat. No. 5,246,433, issued to Hasse, et al. on Sep. 21, 1993; U.S. Pat. No. 5,569,234, issued to Buell et al. on Oct. 29, 1996; U.S. Pat. No. 6,120,487, issued to Ashton on Sep. 19, 2000; U.S. Pat. No. 6,120,489, issued to Johnson et al. on Sep. 19, 2000; U.S. Pat. No. 4,940,464, issued to Van Gompel et al. on Jul. 10, 1990; U.S. Pat. No. 5,092,861, issued to Nomura et al. on Mar. 3, 1992; U.S. patent application Ser. No. 10/171,249, entitled “Highly Flexible And Low Deformation Fastening Device”, filed on Jun. 13, 2002; U.S. Pat. No. 5,897,545, issued to Kline et al. on Apr. 27, 1999; U.S. Pat. No. 5,957,908, issued to Kline et al on Sep. 28, 1999.

The term “machine direction (MD)” or “longitudinal” herein refers to a direction running parallel to the maximum linear dimension of the article and/or fastening material and includes directions within ±45° of the longitudinal direction.

The term “cross direction (CD)”, “lateral” or “transverse” herein refers to a direction which is orthogonal to the longitudinal direction.

The term “joined” encompasses configurations whereby an element is directly secured to another element by affixing the element directly to the other element, and configurations whereby an element is indirectly secured to another element by affixing the element to intermediate member(s) which in turn are affixed to the other element.

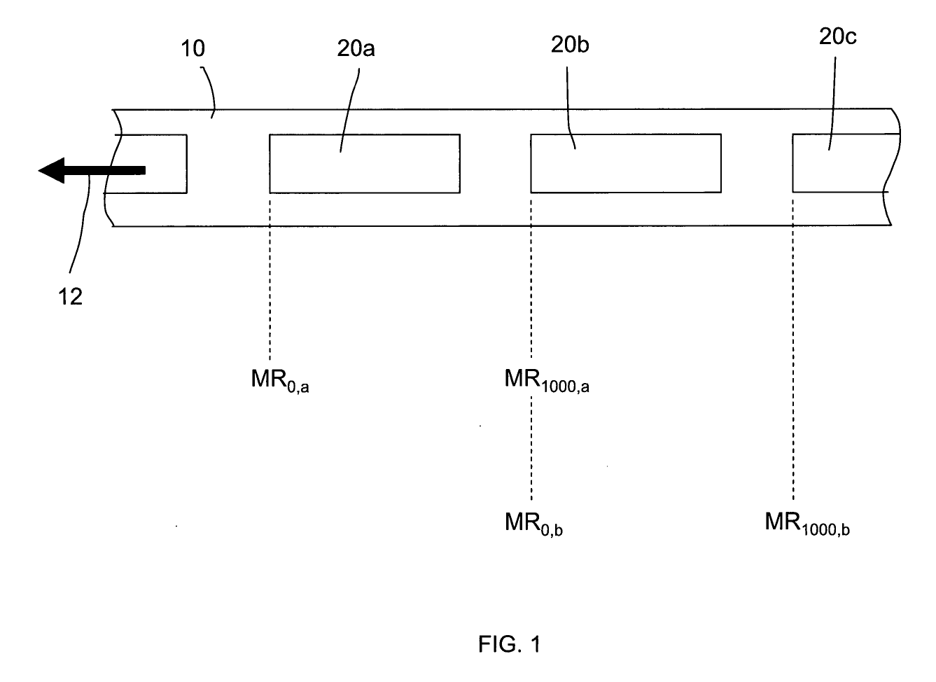

FIG. 1 shows an exemplary continuous web of material 10 that would be suitable for the manufacture of absorbent articles. Web material 10 is shown moving in a machine direction as indicated by arrow 12. In this particular example, absorbent cores 20a, 20b, 20c have been positioned on web material 10 in an MD-spaced relationship. This spaced positioning of said absorbent cores lends itself to cyclical referencing so as to determine positioning of various subsequent processes. For example, the leading edge of a first absorbent core 20a may be referenced by a master referencing count system and assigned a count value of zero. For illustration purposes, this reference point has been labeled MR_{0,a}. The master referencing count system may then proceed to assign single count values until such time that a similar leading edge of an absorbent core is found so as to restart the counting process. For instance, in this particular example, the master referencing count system counts from 0 to 1,000. Accordingly, the leading edge of a second absorbent core 20b is assigned the count value of 1,000 as identified by MR_{1000,a}. While the leading edge of the second absorbent core 20b serves as the ending point 1,000 for the present cycle, said leading edge also serves as a starting point for the next cycle as identified by the label of MR_{0,b}. Similarly, the leading edge of a third absorbent core 20c serves as the ending point 1,000 for the next cycle and is referenced by the label MR_{1000,b}. As will be appreciated throughout the remainder of this application, the use of a master reference counting system as it relates to the leading edge of the absorbent core will prove helpful in the determination of the proper placement of subsequent processes (e.g. placement of discrete parts, severing of the web, etc.).

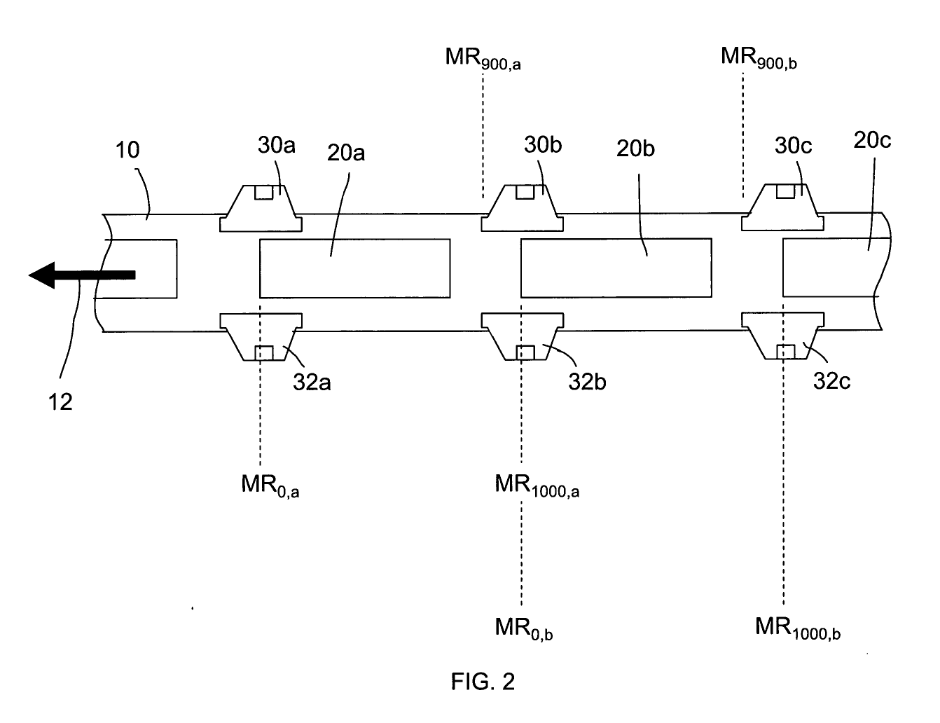

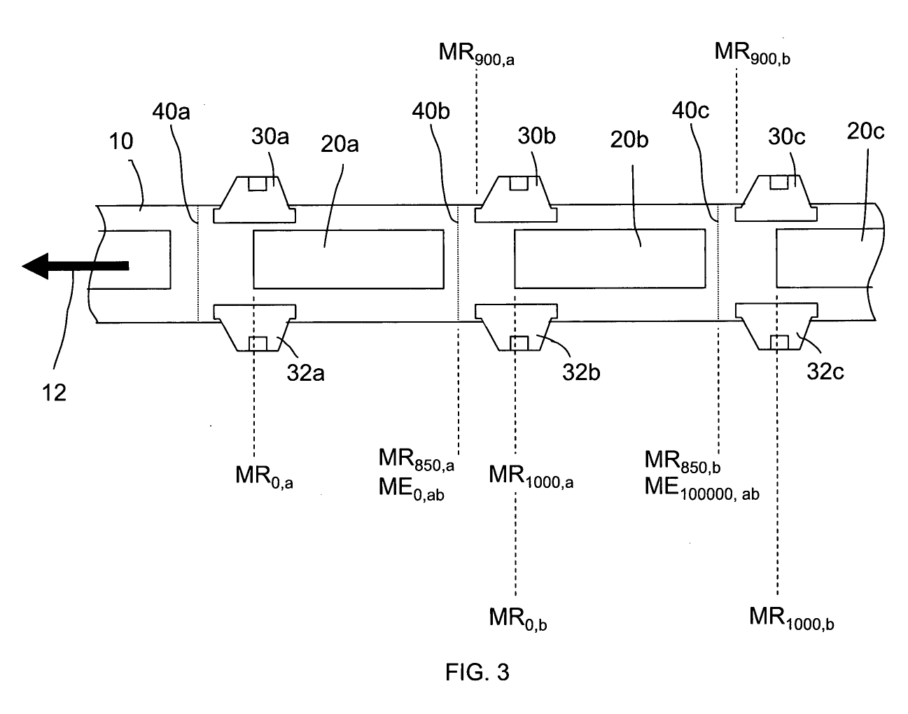

FIG. 2 shows the web and master referencing of FIG. 1 along with the addition of discrete parts 30a, 30b, 30c. In this particular example, said discrete parts take the form of back ears of an absorbent article. Further in this particular example, it is the intent of the manufacturing process to place the leading edge of said back ears at a master reference count value of 900 as identified by the labels of MR_{900,a} and MR_{900,b}. Referring now to FIG. 3, a subsequent processing has been added at a target location of count value 850, namely, a severing action has been performed so as to cut the continuous web of material 10 into discrete products. These cuts are intended to occur at a target location located 50 count values prior to the placement of said back ears. More specifically, these cuts are intended to be placed at a master reference value of 850 as indicated by the label of MR_{850,a} and MR_{850,b}. In addition to the master reference counting system, a similar counting system based on the motor encoder may be used for the severing operation such that a beginning value of 0 may be assigned at the actual cut location (ME_{0,ab}) and an exemplary value of 100,000 may be assigned at the next cut location (ME_{100000,ab}). As will later be appreciated, the use of at least two reference counting systems allows the present invention to modify one system in relationship to the other in order to achieve the proper severing location as it relates to the variable placement of discrete parts.

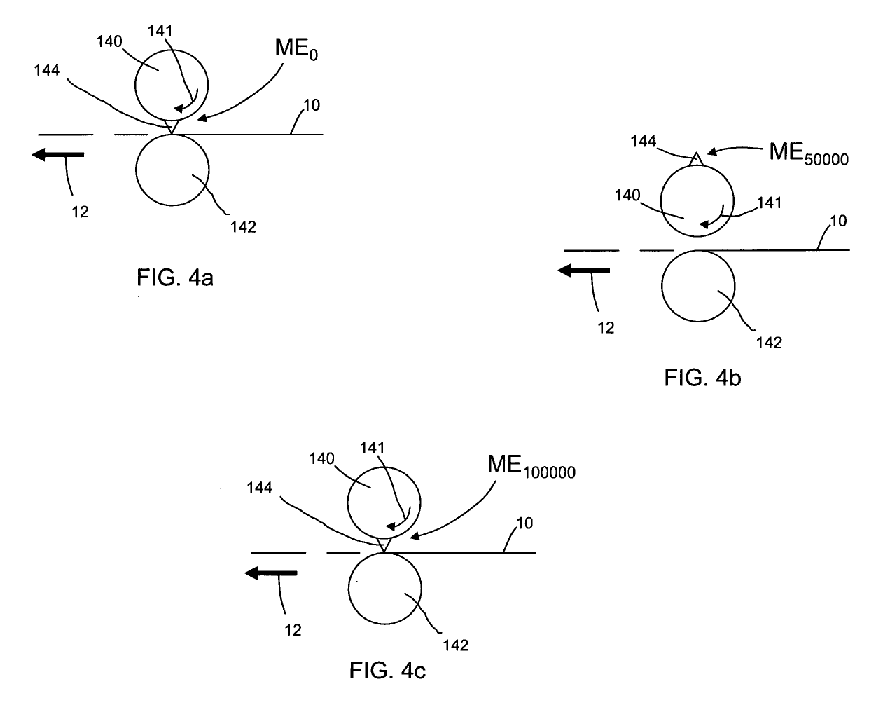

FIG. 4a shows an exemplary severing operation wherein a first roll 140 rotates in a direction as indicated by arrow 141. First roll 140 may include a knife blade 144 which is adapted to sever web material 10 into discrete products. An anvil roll 142 may also be used to help facilitate said severing of the web. As illustrated in this figure, knife blade 144 is at an initial motor encoder reference count value of 0 (ME₀). Next, FIG. 4b shows the severing operation of FIG. 4a wherein the first roll 140 and knife blade 144 have rotated approximately 180° to a motor encoder reference count value of 50,000 (ME₅₀₀₀₀). Lastly, FIG. 4c shows the severing operation wherein first roll 140 and knife blade 144 have made a complete rotation and has begun to cut the next discrete product. Said final position of said knife blade 144 may be referred to as having a count value of 100,000 (ME₁₀₀₀₀₀).

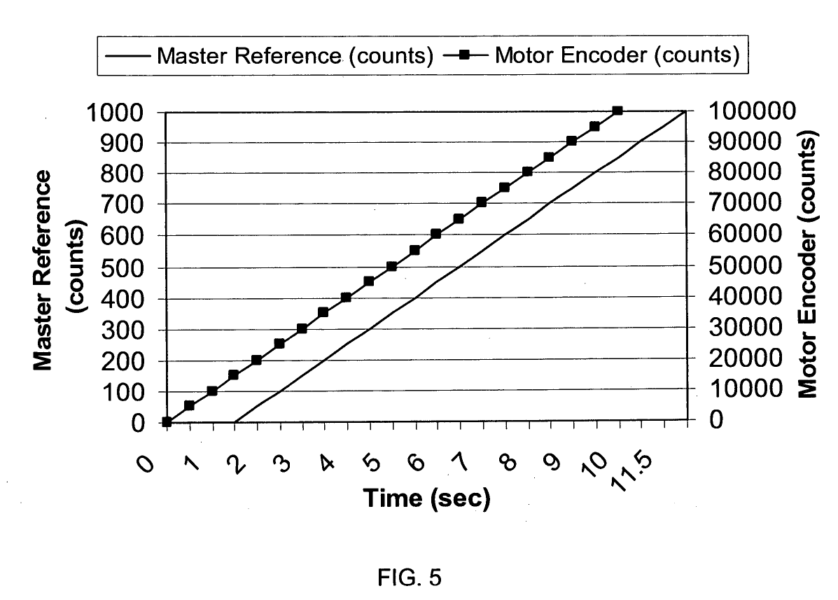

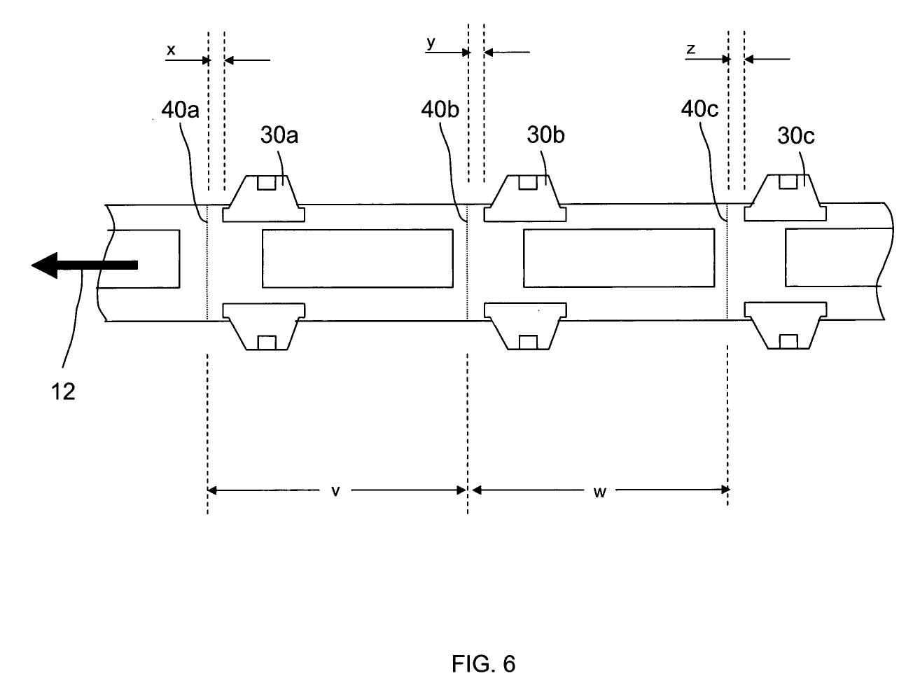

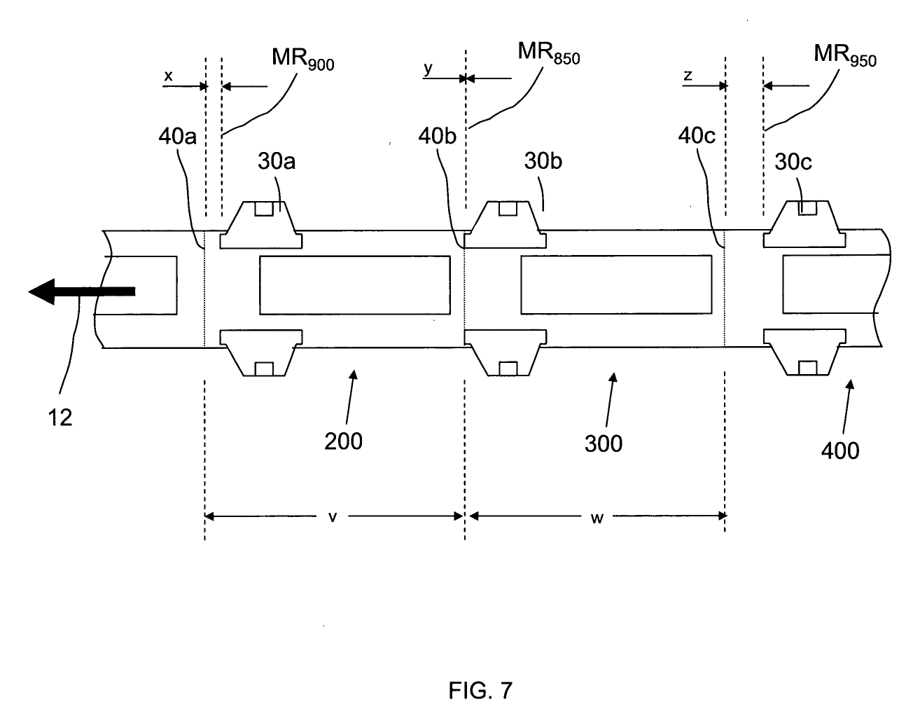

Referring now to FIG. 5, it may be appreciated that the master reference count system and the motor encoder count system may be linear in nature such that the repeating nature of discrete products may be similar to the repeating nature of said severing action. Further, if in fact web material 10 and its components were completely uniform and the manufacturing process free of any process variables, then the ideal product formation shown in FIG. 6 could be realized. In FIG. 6, the distance x between cut 40a and the leading edge of back ear 30a would be identical to similar distances of y and z for this ideal product. Furthermore, the discrete product lengths v and w would also be identical. However, because web material 10 is not completely uniform and because the manufacturing process is not free of any process variables, this ideal product formation cannot be realized. As such, the undesirable product formations shown in FIG. 7 are often more realistic.

In FIG. 7, a first discrete product 200 is shown having the proper distance x between cut 40a and the leading edge of back ear 30a. Also shown is a second discrete product 300 wherein the distance y between cut 40b and the leading edge of back ear 30b is essentially equal to 0. Having cut 40b so close to back ear 30b results in a potential severing of said back ear thus resulting in an unsatisfactory product. Likewise, a third discrete product 400 is shown having a distance z between cut 40c and the leading edge of back ear 30c being too large thus also resulting in an unsatisfactory product. It may be appreciated from the master reference labels within this figure that the unsatisfactory product 300 was largely a result of the improper placement of back ear 30b at a master reference count value of 850 as opposed to its target location of 900. Similarly, for unsatisfactory product 400, the back ear 30c was misplaced at a master reference value of 950. While not desirable, these misplacements of said back ears are a realistic problem within most manufacturing processes. As such, the present invention is directed at remedying these problems.

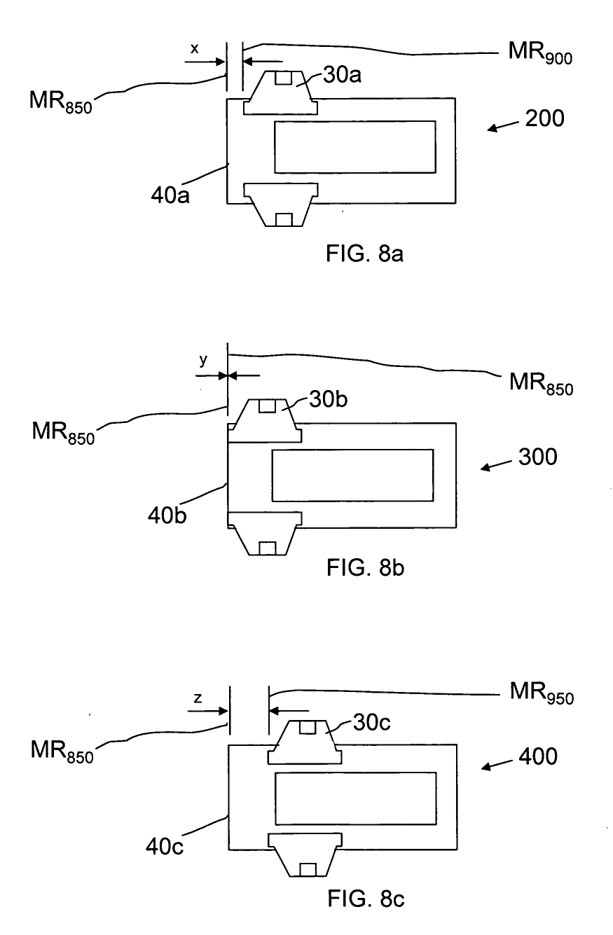

FIG. 8a shows the first discrete product 200 from FIG. 7. As can be further appreciated the back ear 30a was properly placed at a master reference count value of 900 and the subsequent severing was performed at the proper location of master reference count value of 850. In contrast, FIG. 8b shows the second discrete product 300 from FIG. 7 wherein it can be appreciated that the leading edge of back ear 30b and the subsequent cut 40b were both placed at a master reference count value of 850, thus resulting in an unsatisfactory product. Likewise, FIG. 8c shows the third discrete product 400 from FIG. 7 wherein the leading edge of back ear 30c was placed later downstream on the continuous web at a master reference count value of 950. And with the otherwise proper placement of cut 40c at a master reference count value of 850, the resulting distance z is too large thus resulting in an unsatisfactory product.

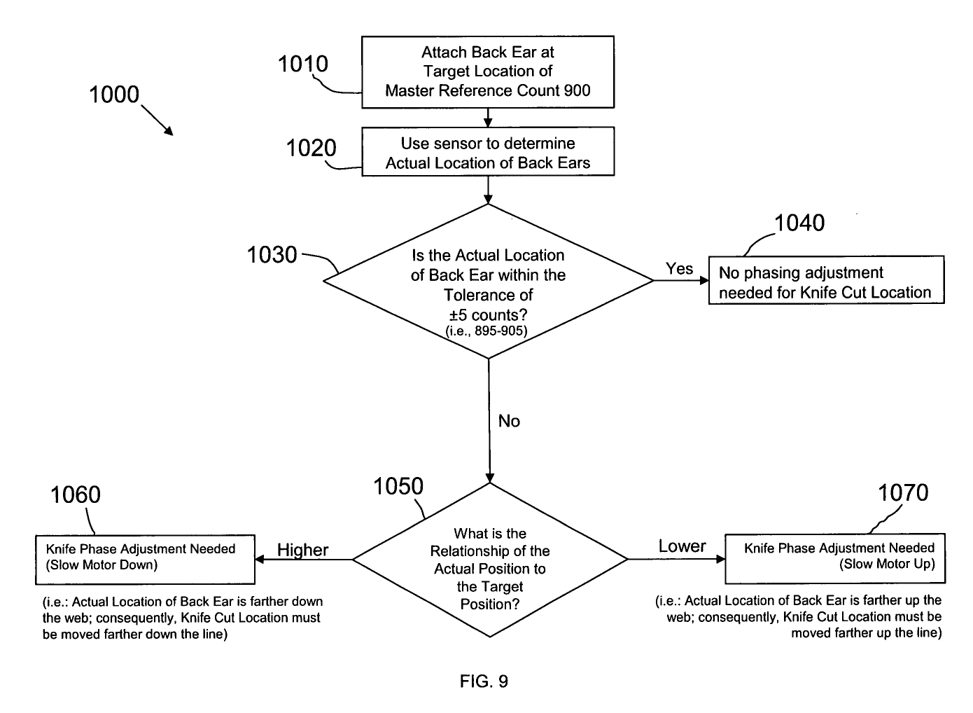

FIG. 9 shows an exemplary flowchart that may be used to remedy the aforementioned placement problems. More specifically, corrective process 1000 may begin with the actual attachment of a back ear to the continuous web at a target location having a master reference count value of 900 as illustrated by step 1010. Next, according to step 1020, a sensor may be used to view the actual placement location of the back ear and transmit a notification to the main processor, which identifies the signal from the sensor with the corresponding master reference count generated within the main processor. Next, according to step 1030, the actual location of the back ear placement is compared within the main processor to a tolerance range, for example, whether the actual location is within five counts of the target location count value of 900 (i.e., the tolerance range being from master reference count values 895 to 905). If the actual location of the back ear is within the tolerance range, then according to step 1040, no phasing adjustment is needed for the knife cut location. If, however, it is determined the actual location of the back ear was not placed within the tolerance range, then according to step 1050, the actual position will be compared to the target position in such a way to determine whether or not the back ear was placed too early or too late. If in fact the actual position count value is higher than the target position count value (i.e., the back ear was placed too late and at a location further down web material 10), then according to step 1060, a knife phase adjustment will be needed so as to make slower the knife cut for that particular discrete product. On the other hand, if the actual position count value is lower than the target position count value (i.e., the back ear was placed too soon and at a location further upstream on web material 10), then according to step 1070, a knife phase adjustment will be needed so as to make faster the knife cut for that particular discrete product.

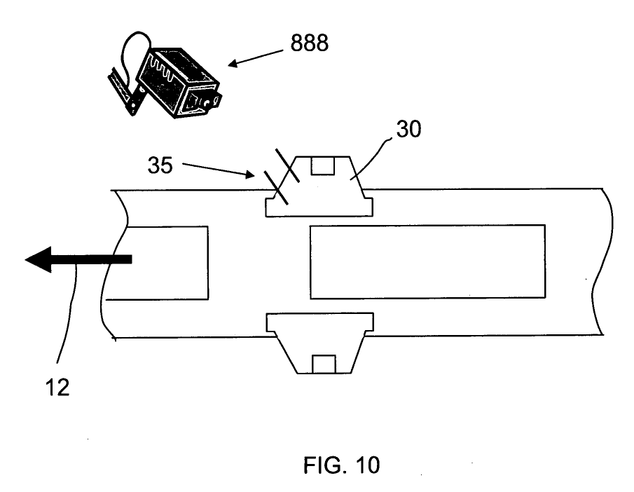

FIG. 10 shows an exemplary sensor 888 (e.g., camera or other suitable device) being used to sense a region of interest 35 along a leading edge of back ear 30. So while most of the embodiments within the present application refer to the leading edge of back ear 30 for location determination, it has also been found that the region of interest 35 may prove useful. Furthermore, one skilled in the art would appreciate that a variety of locations on the discrete part may be sensed in order to determine its actual location.

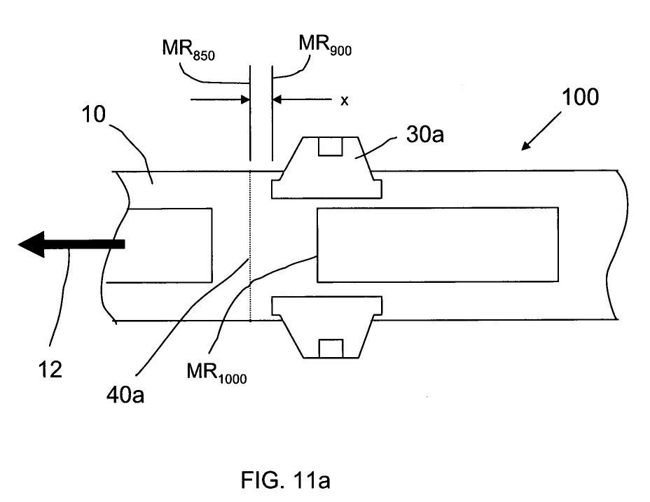

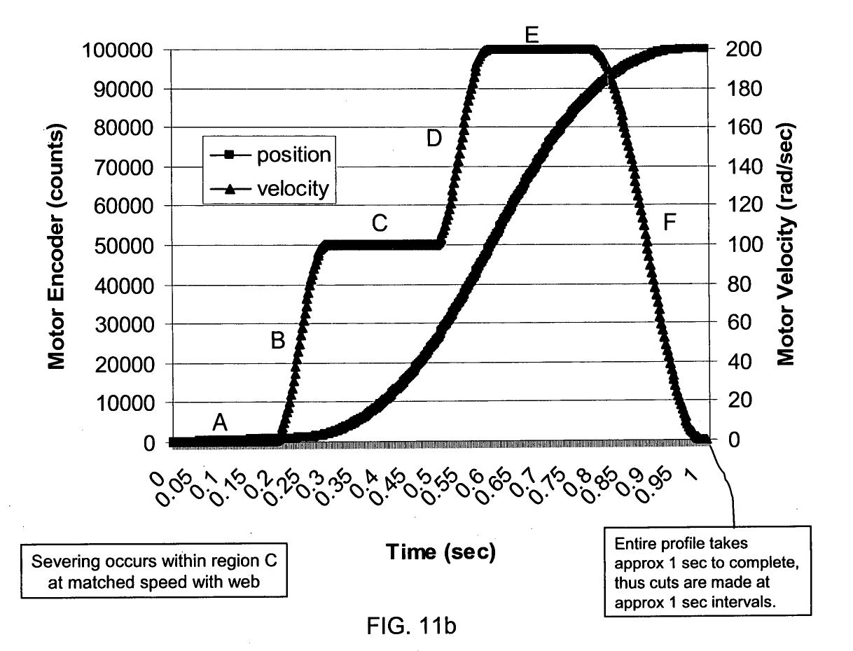

In order to further appreciate the present invention, the following non-limiting examples are provided. FIG. 11a shows an ideal discrete product 100 wherein the leading edge of back ear 30a was properly placed at the target location identified as master reference 900 (MR₉₀₀). Further, this ideal discrete product 100 was severed by a cut 40a at the target location identified as master reference 850 (MR₈₅₀). Consequently, a desired distance therebetween identified as distance x is substantially equal to a target distance of 50 counts. FIG. 11b shows a cam profile graph of the speed changes incurred by knife blade 144 as it relates to the cutting of first discrete product 100 of FIG. 11a. More specifically, it is shown that in region “A” the knife blade 144 is stationary. Next, knife blade 144 accelerates within region “B”. Next, knife blade 144 rotates at a constant velocity within region C and does so at a matched speed of 100 radians per second such that the speed of said knife blade is equal to the surface speed of web material 10 so as to provide a clean cut. Next, knife blade 144 is again accelerated within region “D”. Next, knife blade 144 rotates at a constant velocity within region “E”. Lastly, knife blade 144 decelerates within region “F”. As can be appreciated from the graph, a complete rotation within this particular cycle takes approximately one second to complete, thus according to this cam profile, a knife cut will also occur at approximately one second intervals.

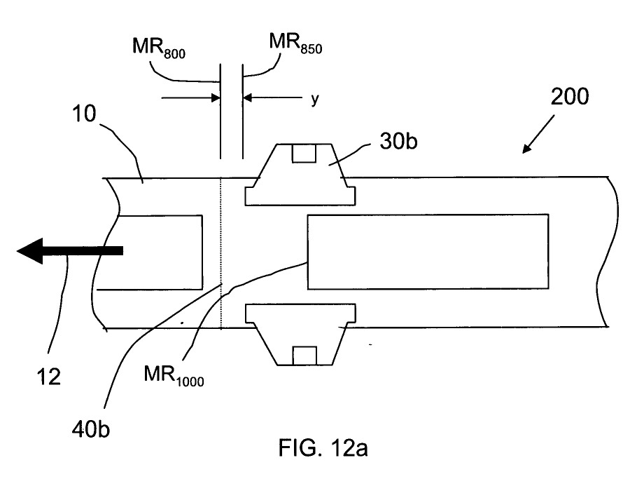

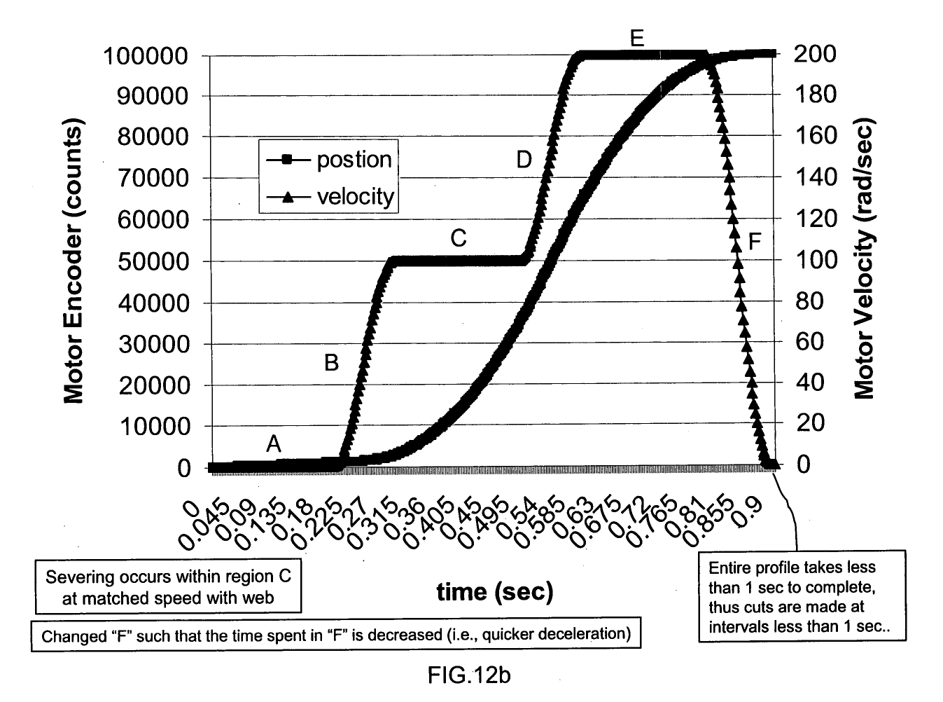

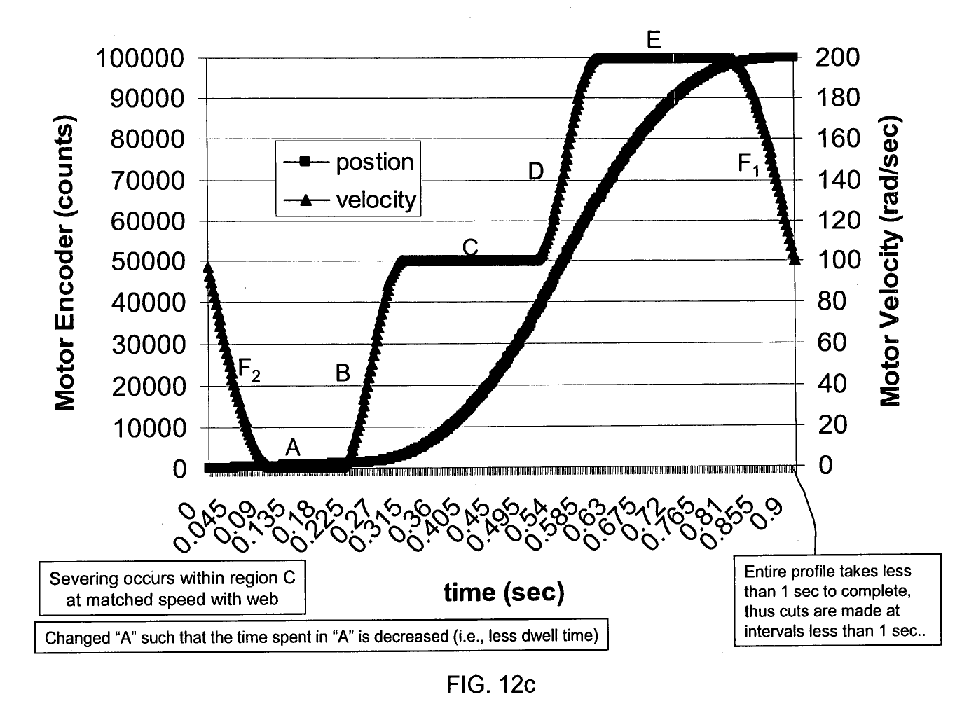

In contrast, FIG. 12a shows a second discrete product 200 wherein the leading edge of back ear 30b was placed too early onto web material 10 at a master reference count value of 850 (MR₈₅₀). In order to sustain the required distance of 50 counts for distance y located between the leading edge of back ear 30b and cut 40b, the actual location of cut 40b must be moved to a master reference count value of 800 (MR₈₀₀). In doing so, the cam profile for knife blade 144 must be adjusted so as to make cut 40b occur earlier in time (e.g., less than one second). Referring now to FIG. 12b, when compared to the original cam profile of FIG. 11b, it can be appreciated that this new cam profile is different in that the time spent in region “F” is decreased. More specifically, the deceleration of knife blade 144 within region F occurs in a shorter period of time such that the entire cam profile may occur in less than one second. Consequently, cut 40b within region “C” will also occur at a time interval less than one second. As such, cut 40b may be made to occur earlier in time so as to preserve the distance of 50 counts for distance y located between the leading edge of back ear 30b and cut 40b. In another exemplary approach for causing cut 40b to occur earlier in time, FIG. 12c shows the cam profile having changed the time spent in region “A” so as to decrease the dwell time. Decreasing the amount of dwell time within region “A” will result in an overall decrease in the amount of time needed to complete the entire cycle (e.g., less than one second). Thus, cut 40b which occurs in region “C” will also occur at a time interval less than one second as required by second discrete product 200.

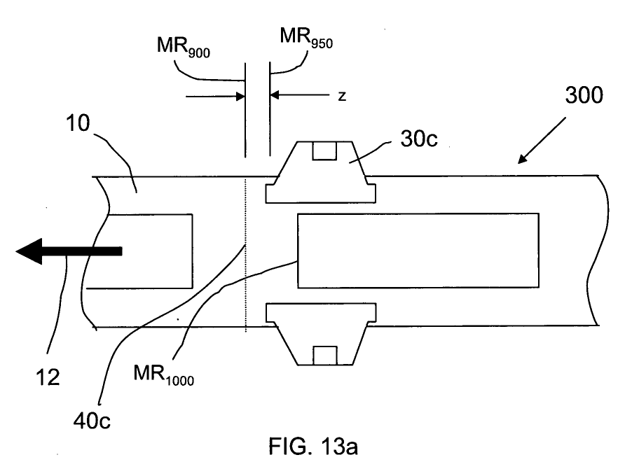

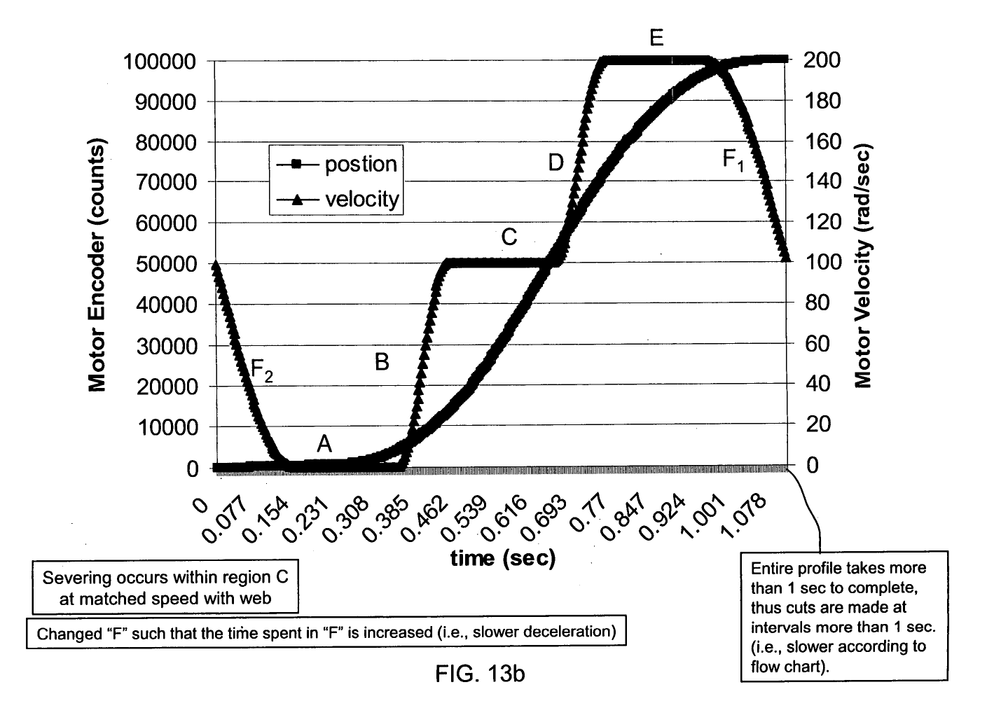

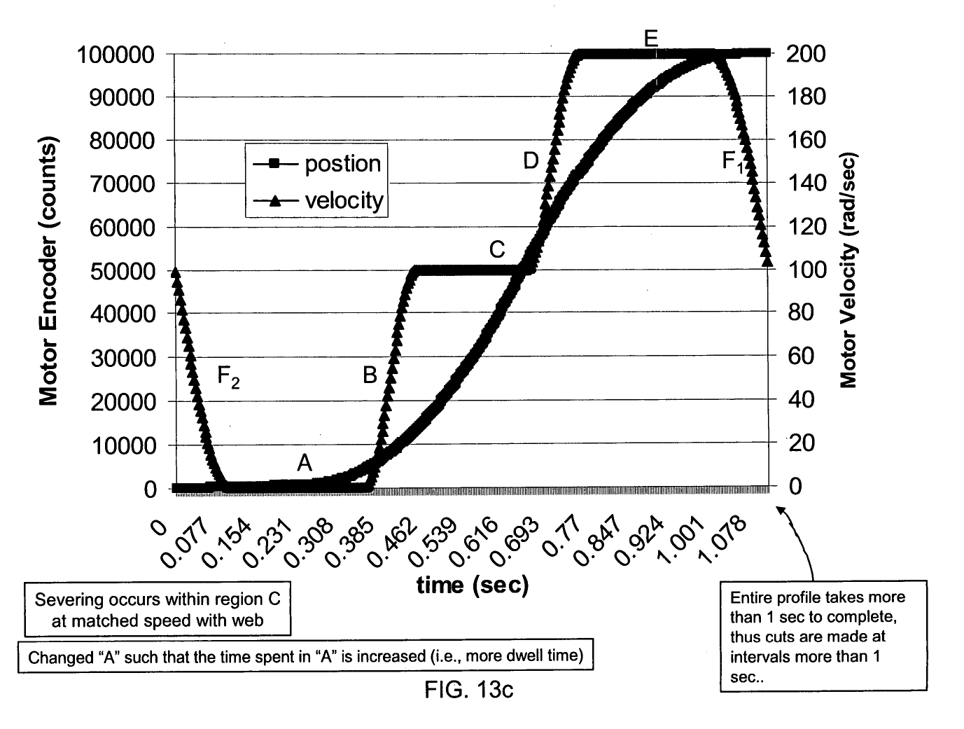

Likewise, FIG. 13a shows a third discrete product 300 wherein the leading edge of back ear 30c was placed too late onto web material 10 at a master reference count value of 950 (MR₉₅₀). In order to sustain the required distance of 50 counts for distance z located between the leading edge of back ear 30c and cut 40c, the actual location of cut 40c must be moved to a master reference count value of 900 (MR₉₀₀). In doing so, the cam profile for knife blade 144 must be adapted so as to make cut 40b occur slower in time (e.g., greater than one second). Referring now to FIG. 13b, when compared to the original cam profile of FIG. 11b, it can be appreciated that this new cam profile is different in that the time spent in region “F” is increased. More specifically, the deceleration of knife blade 144 within region F occurs in a longer period of time such that the entire cam profile may occur in more than one second. Consequently, cut 40c within region “C” will also occur at a time interval greater than one second. As such, cut 40c may be made to occur later in time so as to preserve the distance of 50 counts for distance z between the leading edge of back ear 30c and cut 40c. In another exemplary approach for causing cut 40c to occur later in time, FIG. 13c shows the cam profile being changed such that the time spent in region “A” is increased. Increasing the amount of dwell time within region “A” will result in an overall increase in the amount of time needed to complete the entire cycle (e.g., more than one second). Thus, cut 40c which occurs in region “C” will also occur at a time interval greater than one second as required by third discrete product 300.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

For example, one skilled in the art would appreciate that while a severing action was mostly described in the above embodiments that other subsequent processes may be used without departing from the present invention including, but not limited to, perforating, bonding, imprinting and printing.

In another example, one skilled in the art would appreciate that while back ears were mostly described in the above embodiments that other discrete parts may be used and sensed without departing from the present invention including, but not limited to, absorbent cores, landing zones and wings on feminine products.

In yet another example, one skilled in the art would appreciate that while a leading edge of a discrete part was mostly described in the above embodiments that other reference marks may be used and sensed without departing from the present invention including, but not limited to, the leading edge of an absorbent core, a cut within the product, a registration on the product and a graphic on the product.

In another example, one skilled in the art would appreciate that while adjustments to the cam profile could be made in one deceleration region or in one dwell region, a combination of alterations within multiple deceleration and acceleration regions and dwell regions could be used without departing from the present invention.

In yet another example, one skilled in the art would appreciate that while a single sensor was described in the above embodiments that additional sensors could be added. For instance, a sensor could be added to both sides of the continuous web, one viewing each back ear. The sensors would pass independent signals to the main processor as described above. The processor would compare the independent signals and make corresponding adjustments to the severing action based on the back ear signal that was placed earliest on the continuous web.

What is claimed is:

1. A method of forming a discrete product from a continuous web of material, the discrete product having a discrete part and a minimum distance from the discrete part to its end edge, said method comprising the steps of:
(a) providing a continuous web of material;
(b) placing a discrete part onto the web of material;
(c) determining the location of the discrete part on the web of material;
(d) phasing a subsequent process in relation to the location of the discrete part; and
(e) performing the subsequent process in such a way so as to preserve a minimum distance from the discrete part.

2. The method of claim 1 wherein the subsequent process may be selected from the group consisting of severing, perforating, bonding, imprinting and printing.

3. The method of claim 1 wherein the discrete part may be selected from the group consisting of a back ear, a front ear, an absorbent core, a landing zone and a wing on a feminine product.

4. The method of claim 1 wherein the location of the discrete part on the web of material is determined by the sensing of a product component selected from the group consisting of a leading edge of a discrete part, the leading edge of an absorbent core, a cut within the product, a registration on the product and a graphic on the product.

5. The method of claim 1 wherein the subsequent process includes the severing of the web of continuous material and further includes the use of a knife roll having a knife blade.

6. The method of claim 5 further comprises the use of an anvil roll to facilitate the severing process.

7. The method of claim 1 wherein the subsequent process includes the severing of the web of continuous material thus causing the formation of an end edge, wherein a minimum distance between the discrete part and the end edge is preserved.

8. The method of claim 7 wherein the minimum distance is measured by a reference counting system.

9. The method of claim 1 wherein the location of the discrete part on the web of material is determined by the use of a camera or other suitable device.
